(19) United States
(12) Patent Application Publication
(10) Pub. No.: US 2012/0218763 A1
(43) Pub. Date: Aug. 30, 2012

(54) Wavelength Conversion Light Source Device

(75) Inventors: Jiro Saikawa, Kyoto-shi (JP); Koji Tojo, Kyoto-shi (JP); Yutaka Ido, Kyoto-shi (JP)

(73) Assignee: SHIMADZU CORPORATION, Kyoto-shi, Kyoto (JP)

(21) Appl. No.: 13/504,461

(22) PCT Filed: Nov. 11, 2009
(86) PCT No.: PCT/JP2009/006005

§ 371 Date: Apr. 26, 2012

(51) Int. Cl. F21V 9/00

(52) U.S. Cl. 362/293

(57) ABSTRACT

A device is provided with a semiconductor gain medium (1) having an inclined or curved stripe structure, a Volume Bragg Grating element (3) constituting a resonator with the semiconductor gain medium (1), and a wavelength conversion element (5) which outputs a harmonic wave (H) of a fundamental wave (A) from the resonator. Preferably, the semiconductor gain medium (1) is a frequency incoherent and broadband semiconductor gain medium, the wavelength conversion element (5) is a periodic polarization type nonlinear wavelength conversion element, and the Volume Bragg Grating element (3) and the periodic polarization type nonlinear wavelength conversion element (5) have a grating period having a chirped structure.

### TECHNICAL FIELD

The present invention relates to a wavelength conversion light source device and, more specifically, to a wavelength conversion light source device that is capable of stable high-speed modulation.

### BACKGROUND ART

A wavelength conversion laser device including a superluminescent diode, Brewster plate, bandpass filter and a wavelength conversion waveguide has been known in the art (see for example FIG. 2 in Patent Literature 1). Also known in the art are a wavelength conversion laser device including a superluminescent diode, bandpass filter and wavelength conversion waveguide (see for example FIG. 3 in Patent Literature 1), and wavelength conversion laser device including a superluminescent diode, wavelength conversion waveguide and grating (see for example FIG. 4 in Patent Literature 1).

### PRIOR ART LITERATURE

### Patent Literature

Patent Literature 1: Unexamined Patent Application Publication No. H09-186387

### OVERVIEW OF THE INVENTION

### Problems to Be Solved by the Invention

The aforesaid previous wavelength conversion laser devices are beset with a problem of difficulty in achieving stable high-speed modulation due to the difficulty in temperature control arising from the use of many component parts or the integration of parts having differing temperature characteristics.

It is therefore the object of the present invention to provide a wavelength conversion light source device wherein stable high-speed modulation can be easily performed.

### Means for Solving the Problems

With a first perspective, the present invention provides a wavelength conversion light source device including: a semiconductor gain medium (1) having an inclined or curved stripe structure that is angled so that a resonator is not formed by reflection at, at least, the light emitting end surface of an optical waveguide; a Volume Bragg Grating element (3) that forms a resonator with the semiconductor gain medium (1); and a wavelength conversion element (5) that outputs a harmonic wave of a fundamental wave from the resonator.

In the afore-described configuration, a Volume Bragg Grating (VBG) device refers to a structure wherein gratings are formed within a glass block unlike an optical waveguide structure like a fiber. The grating is formed to be inclined with respect to the end surface of the glass block. The end surface is provided with a coating that is anti-reflective to the fundamental wave light and coating that is reflective to the wavelength converted light.

Ordinary Fabry-Perot resonators (which use reflection at the end surface of the semiconductor gain medium) oscillate at frequencies whose mode interval is determined by the resonator length. For this reason, a problem of mode hopping occurs wherein the oscillation mode changes to a different frequency due to factors such as changes in temperature. Even when a wavelength selection device is used, the wavelength may deviate from the wavelength-tolerance range of a non-linear wavelength conversion element. Furthermore, interference by external mirrors and semiconductor laser can generate optical noise, which makes it difficult to obtain wavelength converted light of a low noise.

However, because, with the wavelength conversion light source device (100, 200) according to the afore-described first perspective, the optical waveguide uses a semiconductor gain medium with an inclined or curved stripe structure that is angled so that a Fabry-Perot resonator is not formed by reflection at, at least, the light emitting end surface, the afore-described problems are solved.

Furthermore, because a Volume Bragg Grating element is used, manufacturing is simplified, and because the number of component parts is few and each of the components are used as separate structures, temperature control is facilitated.

Hence, stable high-speed modulation of low noise is easily achieved, and device size can also be easily reduced.

With a second perspective, the present invention provides a wavelength conversion light source device (200) according to the afore-described first perspective wherein the semiconductor gain medium (1) is a frequency incoherent and broadband semiconductor gain medium, the wavelength conversion element (5) is a periodic poling type nonlinear wavelength conversion element, and the Volume Bragg Grating element (3) and the periodic poling type nonlinear wavelength conversion element (5) have a grating period with a chirped structure.

With the wavelength conversion light source device (200) according to the second perspective, the semiconductor gain medium (1) outputs a wider-band fundamental wave, and since the selection wavelength is made variable by the use of a Volume Bragg Grating element (3) and periodic poling type nonlinear wavelength conversion element (5) having a grating period with a chirped structure, wavelength tunability of a broad band is realized.

### Effects of the Invention

With the wavelength conversion light source device according to the present invention, stable high-speed modulation with low noise can be easily achieved. Reduction in size can also be easily achieved. Furthermore, widely wavelength tuning can also be realized.

### BRIEF DESCRIPTION OF THE FIGURES

FIG. 1 shows the configuration of embodiment 1 of the wavelength conversion light source device.

FIG. 2 is a graph showing the current-fundamental oscillation wavelength dependence of embodiment 1 of the wavelength conversion light source device.

FIG. 3 is a graph showing the change over time in the output of the wavelength converted light with embodiment 1 of the wavelength conversion light source device.

FIG. 4 is a graph showing the change over time in the output of the wavelength converted light with embodiment 1 of the wavelength conversion light source device.

FIG. 5 shows the configuration of embodiment 2 of the wavelength conversion light source device.

FIG. 6 is a graph showing the tunablity of the fundamental wave with embodiment 2 of the wavelength conversion light source device.

### MODES FOR PRACTICING THE INVENTION

Embodiments of the present invention are described next in greater detail with reference to figures. However, the present invention is not limited by the embodiments.

### Embodiments

### Embodiment 1

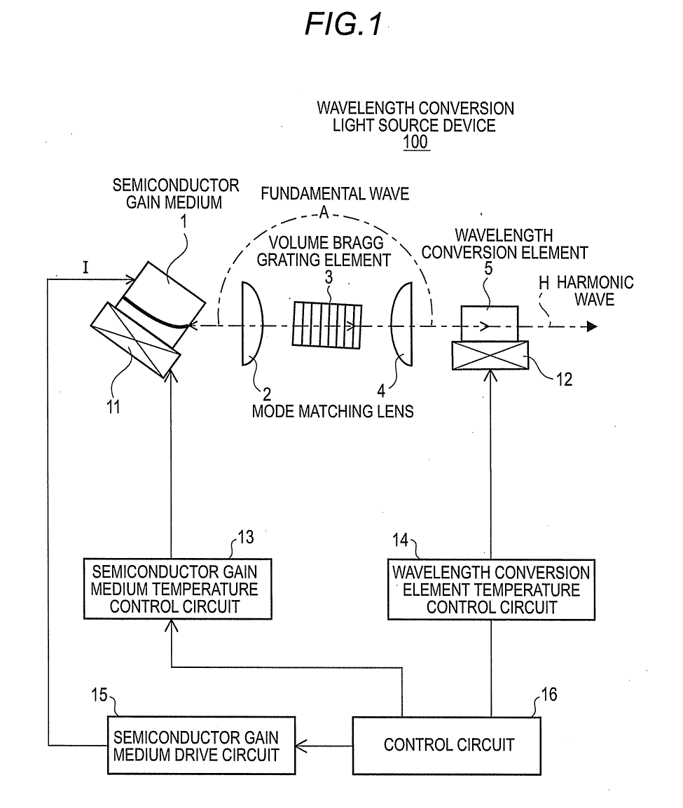

FIG. 1 shows the configuration of embodiment 1 of a wavelength conversion light source device 100.

The wavelength conversion light source device 100 includes a frequency incoherent and broadband semiconductor gain medium 1 having an inclined or curved optical waveguide structure that is angled so that a resonator is not formed by reflection at, at least, the light emitting end surface of the waveguide, a mode matching lens 2, a Volume Bragg Grating element 3 that forms a resonator with the semiconductor gain medium 1, a mode matching lens 4, a wavelength conversion element 5 that outputs harmonic wave H of fundamental wave A from the resonator, temperature adjustment unit 11 having a Peltier device and a temperature sensor for adjusting the temperature of the semiconductor gain medium 1, a temperature adjustment unit 12 for adjusting the temperature of the wavelength conversion element 5, a semiconductor gain medium temperature control circuit 13 that uses the temperature adjustment unit 11 to control the temperature of the semiconductor gain medium 1, a wavelength conversion element temperature control circuit 14 that uses the temperature adjustment unit 12 to control the temperature of the wavelength conversion element 5, a semiconductor gain medium drive circuit 15 that outputs injection current I for driving the semiconductor gain medium 1, and a control circuit 16 that controls the semiconductor gain medium drive circuit 15 and also controls the respective temperature control circuits 11 and 12.

The semiconductor gain medium 1 may be, for example, a superluminescent diode.

To reduce unnecessary optical feedback from its end surface, the Volume Bragg Grating element 3 is positioned to be inclined with respect to the optical axis.

The wavelength conversion element 5 is a wavelength conversion waveguide of the periodic polarization inversion type that uses generally available LiNbO₃ or LiTaO₃. A periodic polarization inversion type wavelength conversion waveguide such as this has TM polarization but the semiconductor gain medium 1 has TE polarization. Because of this, semiconductor gain medium 1 and periodic polarization inversion type wavelength conversion waveguide 5 are positioned so that the polarization matches between the two. At the same time, the mode-matching lens 4 is used to increase coupling efficiency so that the number of parts and device size are reduced.

The end surface of the wavelength conversion element 5 is finished with a wedge to reduce unnecessary optical feedback.

LBO crystal, KTP crystal and bulk perodic polarization inversion devices without a waveguide structure can also be used as the wavelength conversion element 5.

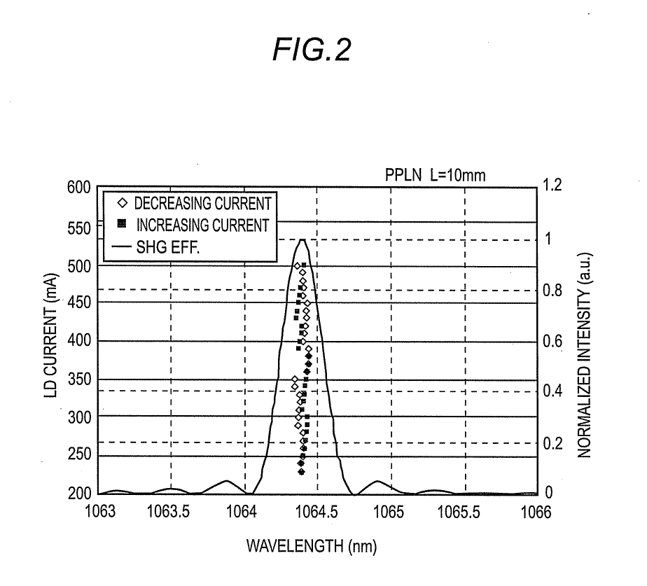

FIG. 2 shows a plot of the variation in wavelength of the fundamental wave A as injected current Ito the semiconductor gain medium 1 is changed, and the wavelength tolerance range of the periodic polarization inversion type wavelength conversion waveguide 5. Even when injected current I is changed, the wavelength of the fundamental wave A remains within the wavelength tolerance range of the cyclic polarization inversion type wavelength conversion waveguide 5.

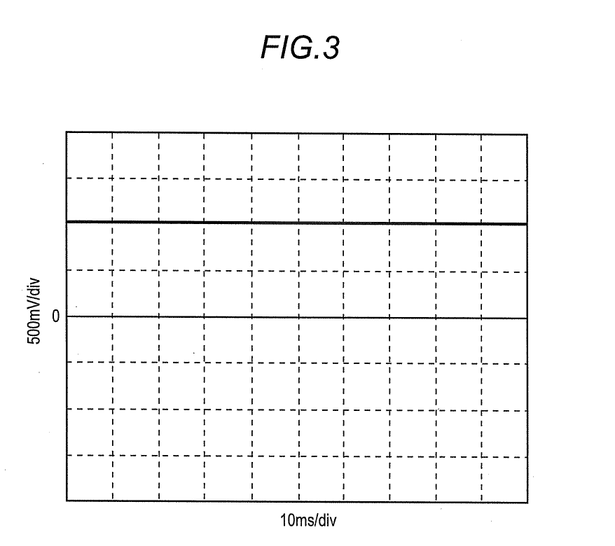

FIG. 3 shows the change over time of the harmonic wave H when a fixed injected current I is provided to the semiconductor gain medium 1.

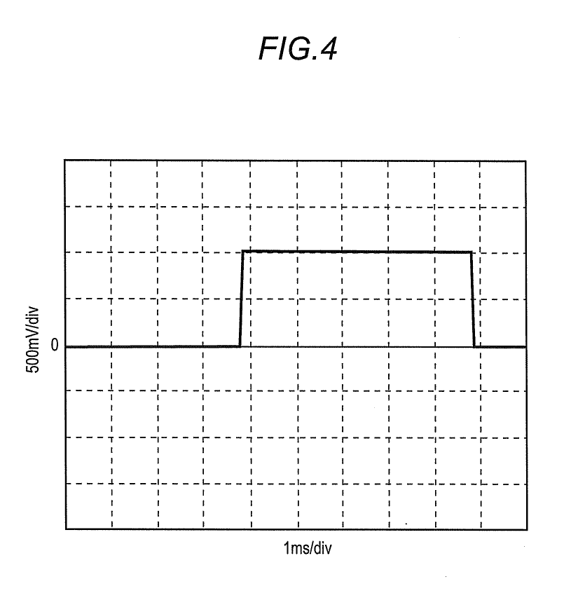

FIG. 4 shows the change over time of the harmonic wave H when an injected current I of a square wave pattern is provided to the semiconductor gain medium 1.

The Volume Bragg Grating element 3 exhibits only small changes in the selection wavelength to temperature variations, and due to the resonator that is formed with the semiconductor gain medium 1, the oscillation wavelength mode intervals are narrower than those of ordinary semiconductor lasers so that wavelength hopping to outside of the narrow wavelength width due to changes in refractive index to injected current I is suppressed and stably controlled.

The result is a stable output (output of high fidelity to injected current I) and allows a high-speed modulation of the fundamental wave A.

The wavelength conversion light source device 100 of embodiment 1 provides the following effects.

(1) Wavelength converted light that can be stably modulated at a high speed.
(2) Minimal number of parts and space between parts, which facilitates size reduction.
(3) Because of the use of Volume Bragg Grating element 3, manufacturing is facilitated.
(4) Because the Volume Bragg Grating element 3 and the wavelength conversion element 5 are formed as separate units, temperature control is facilitated.

### Embodiment 2

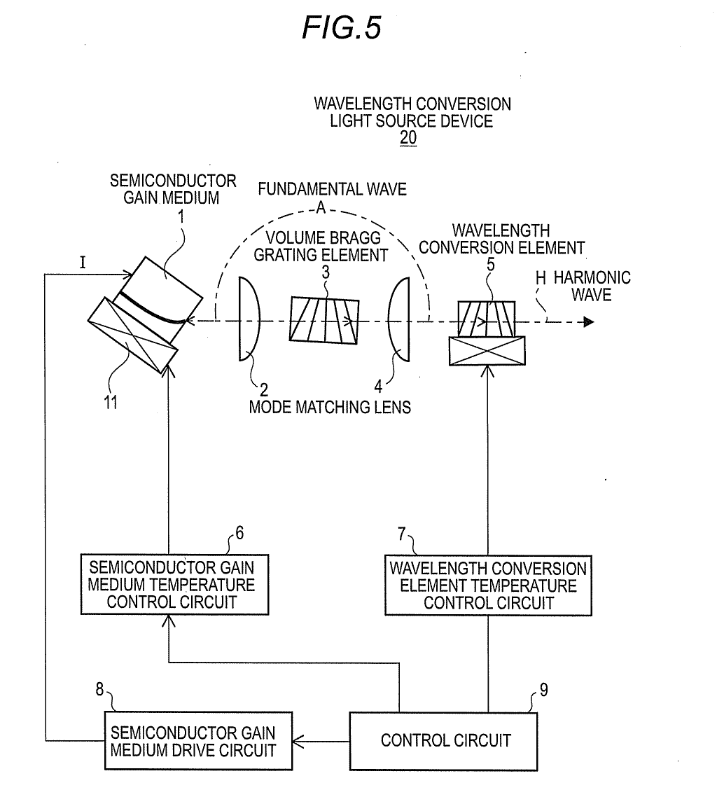

FIG. 5 shows the configuration of embodiment 2 of the wavelength conversion light source device 200.

The wavelength conversion light source device 200 is basically the same as the wavelength conversion light source device 100 of embodiment 1, but with embodiment 2, the semiconductor gain medium 1 is a frequency incoherent and broadband semiconductor gain medium, and the Volume Bragg Grating element 3 and periodic polarization type nonlinear wavelength conversion element 5 have a grating period with a chirped structure.

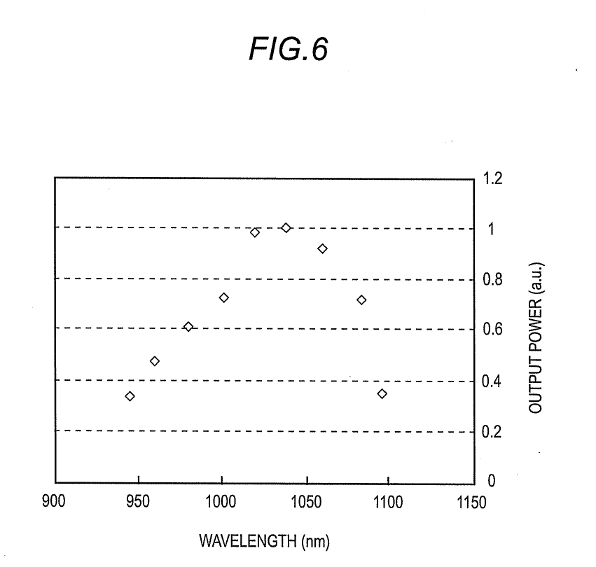

FIG. 6 is a graph showing the wavelength tunability of the fundamental wave.

The semiconductor gain medium 1 can oscillate over a wide wavelength band of approximately 100 nm or more while suppressing wavelength hopping.

With the wavelength conversion light source device 200 of embodiment 2, wavelength tunability can be achieved without an accompanying change in optical axis.

### INDUSTRIAL USABILITY

The wavelength conversion light source device according to the present invention can be used in such fields as analytical instrumentation, medicine, optical information processing, laser displays and the like.

### DESCRIPTION OF THE NUMERICAL REFERENCES

1. Semiconductor gain medium
2, 4. Mode matching lens
3. Volume Bragg Grating element
5. Wavelength conversion element
100, 200. Wavelength conversion light source device

What is claimed is:

1. A wavelength conversion light source device comprising:
a semiconductor gain medium having an inclined or curved stripe structure that is angled so that a resonator is not formed by reflection at, at least, the light emitting end surface of an optical waveguide;
a Volume Bragg Grating element that forms a resonator with said semiconductor gain medium; and
a wavelength conversion element that outputs a harmonic wave of a fundamental wave from said resonator.

2. The wavelength conversion light source device according to claim 1 wherein:
said semiconductor gain medium is a frequency incoherent and broadband semiconductor gain medium;
said wavelength conversion element is a periodic poling type nonlinear wavelength conversion element; and
said Volume Bragg Grating element and said periodic poling type nonlinear wavelength conversion element have a grating period with a chirped structure.
